(19) United States
(12) Patent Application Publication
(10) Pub. No.: US 2010/0126946 A1
(43) Pub. Date: May 27, 2010

(54) SYSTEM AND MOTHOD FOR FILTERINGEITH SAFETY FEATURES

(76) Inventor: William H Morgan, Centre Hall, PA (US)

Correspondence Address: Botkin & Hall, LLP, 105 E.Jefferson Boulevard, Suite 400, South Bend, IN, 46601, US

(21) Appl. No.: 12/451,582

(22) PCT Filed: May 23, 2007
(86) PCT No.: PCT/US2007/012330

§ 371 Date: Nov. 19, 2009

(51) Int. Cl. B01D 35/30; B01D 37/00

(52) U.S. Cl. 210/767; 210/232

(57) ABSTRACT

A fluid filtering system includes a housing portion and a lid portion, with a safety pin mechanism extending through the lid portion which prevents the fluid filtering system from operating correctly through visual indicators. A vent bore is included in the housing which includes a vent gasket therein for proper seating of the lid portion against the housing portion to prevent leakage of fluid being filtered. An inner circumferential gasket is also included to secure the lid portion to the housing portion and to prevent fluid leakage. A camming interface between the lid portion and the housing portion assures a secure fit of both the lid portion and the housing portion; the safety pin mechanism disallows the lid portion from being removed from the housing portion, thereby preventing accidental, and unsafe, release of the lid portion from the housing portion.

### CROSS REFERENCE TO RELATED APPLICATIONS

This application is a continuation-in-part of U.S. patent application Ser. No. 10/972,976, filed Oct. 25, 2004 and U.S. patent application Ser. No. 10/972,978, filed Oct. 25, 2004, the disclosures of which are hereby incorporated by reference.

### BACKGROUND OF THE INVENTION

1. Field of the Invention

The present invention relates to fluid filtering systems and, more specifically, to fluid filtering systems having an interior filter element and which may include modular housing.

2. Description of the Background of the Invention

Fluid filtering systems have many manufacturing and processing applications. Conventional fluid filters typically utilize a filter element that takes the form of a filter cartridge or a filter bag. Although known filtering systems are effective, it would be useful to provide a cost-effective approach to prevent accidental rupture of a fluid filtering system, and to provide indicators that a fluid filtering system is in a proper state to allow it to filter fluids.

It is therefore becoming increasingly necessary to provide fluid filter systems which include multiple safety features for detecting an improperly seated lid portion in connecting to a housing portion of a fluid filtering system.

### SUMMARY OF THE INVENTION

The present invention is directed to an improved fluid filtering system useful in filtering fluids of various types.

According to one aspect of the present invention, a fluid filter assembly is provided with a housing portion and a lid portion to filter fluid. The housing portion includes an access opening through which a filter element is inserted. The lid portion is utilized to cover the access opening secure itself to the housing portion. The housing portion also includes an inlet opening and an outlet opening through which fluid is allowed to pass when the fluid filtering system is operational.

According to another aspect of the present invention, the housing portion further includes a plurality of vent bores and vent gaskets which are covered by cam locking portions of the lid portion when the lid portion and the housing portion are secured together. The vent bores and vent gaskets serve to indicate a fluid-tight seal between the housing portion and the lid portion.

In another aspect of the present invention, the lid portion includes a circumferential gasket which seats against an inner radial surface of an upper lip of the housing portion when the lid portion and the housing portion are secured together. The circumferential gasket serves to indicate a fluid-tight seal between the inside of the housing portion and an inner cylindrical lip of the lid portion

In a further aspect, the present invention provides a safety pin included in the lid portion designed to give a visual indication of an unseated lid portion and to physically secure the lid portion from being removed accidentally from the housing portion. The safety pin includes an internal spring and a plunger which is seated against a cam locking portion of the housing portion when the lid portion is correctly seated thereon; the plunger must be suitably raised from its contact with the cam locking portion for the lid portion to be unseated from the housing portion successfully.

The various features of the present invention will become more readily apparent from a consideration of the following description of the illustrative embodiments thereof, to be read in conjunction with the accompanying drawings, in which like reference numerals represent same or similar items.

### BRIEF DESCRIPTION OF THE DRAWINGS

Preferred exemplary embodiments of the present invention are illustrated in the accompanying drawings, in which like reference numerals represent like parts throughout, and in which:

FIG. 1 is a fragmentary plan view of a fluid filtering system in accordance with the present invention, shown in a closed position;

FIG. 2 is a cross-sectional view taken along line 2-2 of FIG. 1;

FIG. 3 is an enlarged view of the spring locking mechanism of FIG. 2;

FIG. 4 is a side elevational view shown in cut-away of the fluid filtering system taken from a view along line 4-4 of FIG. 1, shown in a closed position;

FIG. 5 is a side elevational view shown in cut-away of the fluid filtering system of FIG. 4, shown in an intermediate position;

FIG. 6 is a side elevational view shown in cut-away of the fluid filtering system of FIG. 4, shown in an open position; and

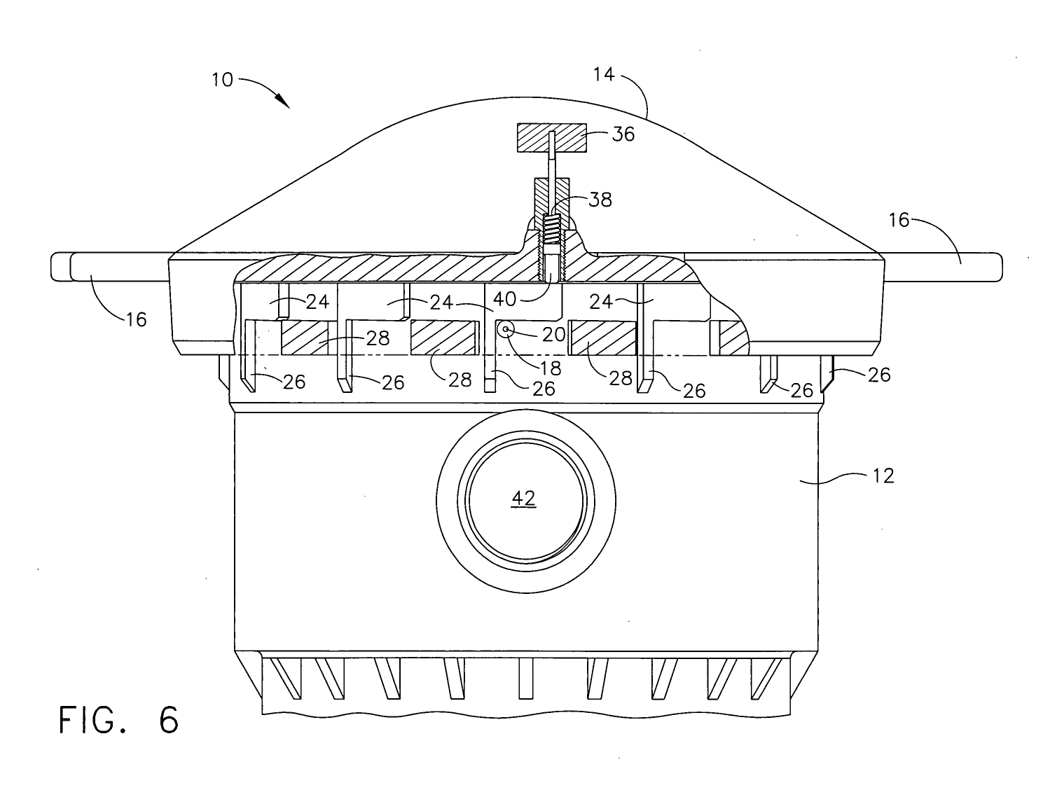

FIG. 7 is a fragmentary plan view of the fluid filtering system, shown in an open position.

### DETAILED DESCRIPTION OF INVENTION

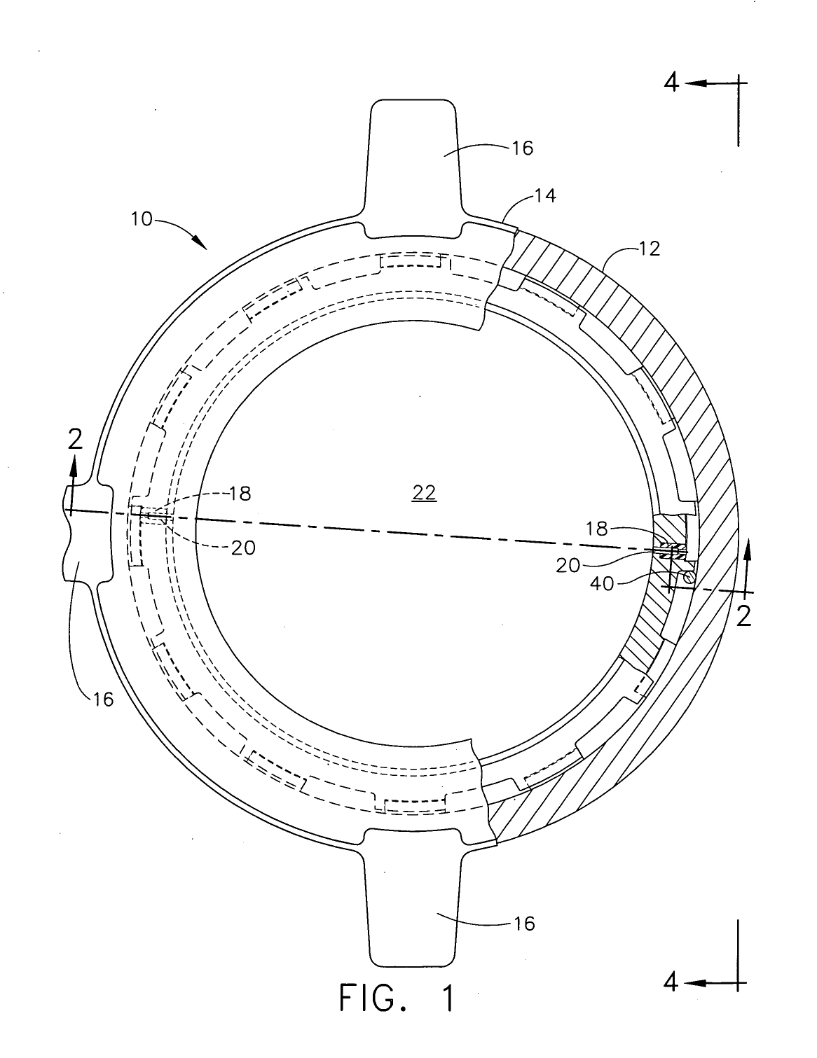

The present invention generally discloses an improved fluid filtering system in the form of a filter assembly 10, as shown in FIG. 1. The filter assembly 10 includes a housing portion 12 and a lid portion 14 having handles 16. The housing portion 12 includes an inlet opening 42 and an outlet port (not shown) by which fluid may be introduced into and flows out through the fluid filter assembly. Such a housing portion 12 may be of the modular type as described in U.S. patent application Ser. No. 10/972,978 or a non-modular type as described in U.S. patent application Ser. No. 10/972,976. In addition, such a housing portion 12 may be adapted to retain a filter element (not shown) within the filter housing portion 12, which may be of a filter basket/filter bag combination, a filter cartridge, or any suitable type of filter element which may be placed within the filter housing portion 12 through an access opening 22 to accept fluid passage therethrough.

The housing portion 12 may be manufactured from any suitable material, including 316 stainless steel, 304 stainless steel, carbon steel, or polypropylene. In the illustrated embodiment, polypropylene with a 20% glass fill is used. As is known in the art, various internal coatings may be employed for use with the housing portion 12 depending upon the material used to form the housing portions 12, the filter assembly 10, and the application for which the fluid filtering system is to be used.

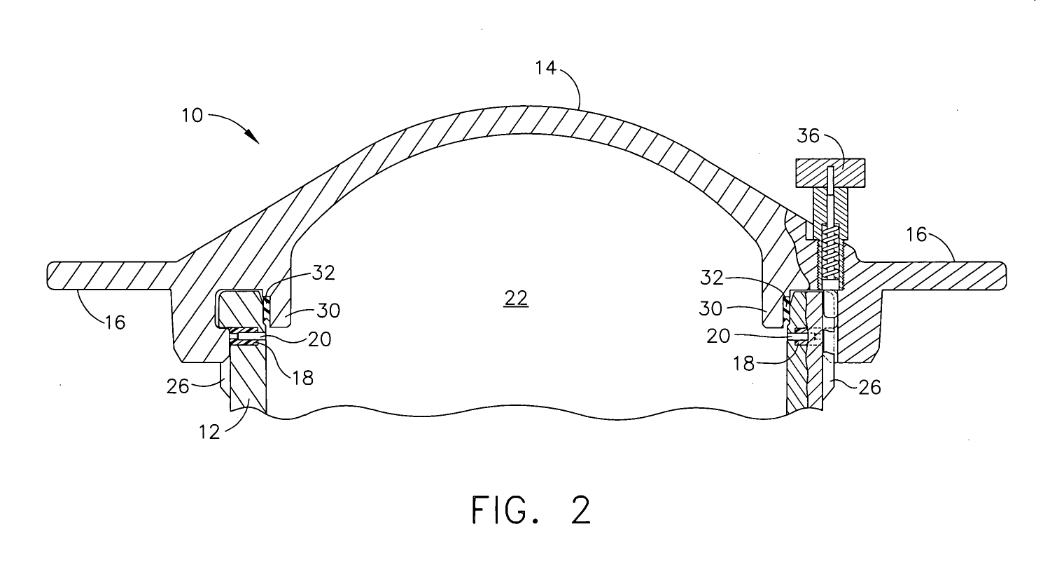

As shown in FIG. 1, a cut-away of the lid portion 14 is shown interfacing with the housing portion 12 through a camming interface, which will be described in further detail below. Also shown are vent bores 20 in the housing portion 12 with vent gaskets 18 fitted therein. Turning to FIG. 2, two vent bores 18 can be seen opposite each other on an upper rim of the housing portion 12. In the illustrated embodiment, two vent bores 20 are shown, but a plurality of vent bores 20 may be included, limited only by the number of camming members located on the housing portion 12. As seen in FIG. 2, vent bores 20 are fashioned to accept vent gaskets 18 therethrough, leaving a circumferential portion of the vent gaskets 18 extending outward of the housing portion 12. A lid portion cam locking member 28 is removably positioned over the extending circumferential portion of each vent gasket 18, when the housing portion 12 and the lid portion 14 are interfaced, so that the extending circumferential portion of each vent gasket 18 engages each lid portion cam locking member 28 to provide a seal between the lid portion 14 and the housing portion 12. When the lid portion 14 is removed from the housing portion 12, or not properly seated, fluid is designed to pass through vent bores 20 to indicate to the operator of the fluid filtering system that the lid portion 14 and the housing portion 12 are not correctly aligned and to cease operation of the system.

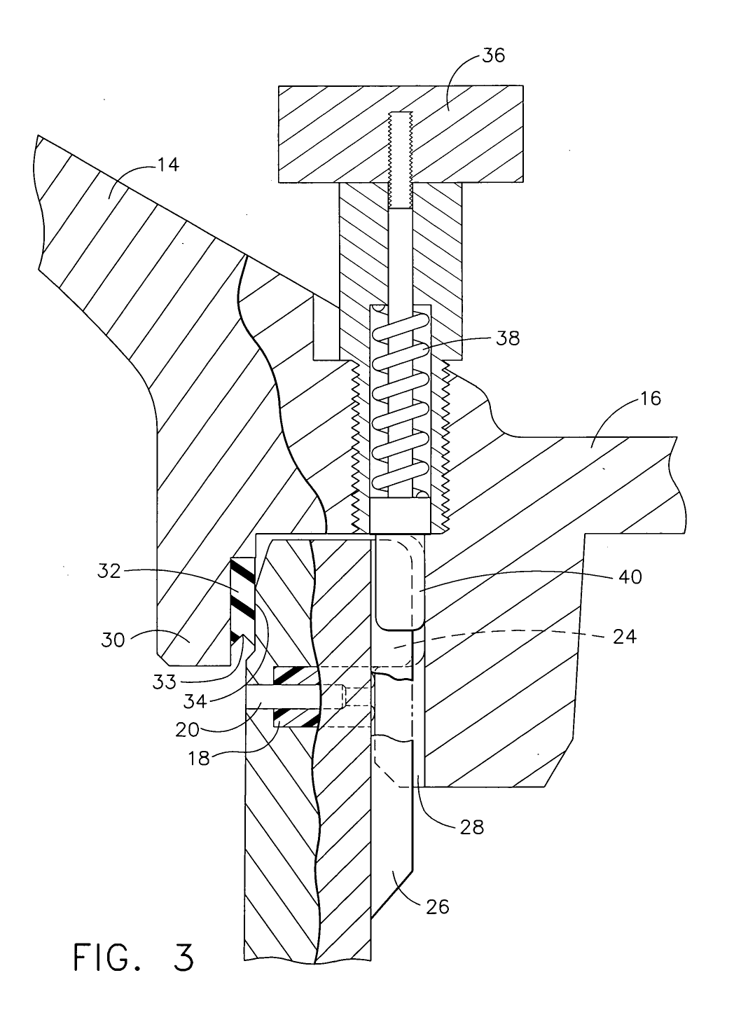

A vertically extending cylindrical lip 30 can also be seen in FIG. 2, which has attached to it a cylindrically extending gasket 32. Referring to FIG. 3, the gasket 32 has an open end 33 so as to be able to be compressed into engagement with an inner radial surface 34 of the housing portion 12 when the lid portion 14 is seated on the housing portion 12. The gasket 32 provides a seating mechanism for the lid portion 14 to be in proper engagement with the housing portion 12 and to disallow fluid from exiting the housing portion 12 during operation of the fluid filtering system.

The fluid filter assembly 10 also includes a safety pin 36 fitted to the lid portion 14. The safety pin 36 includes a portion extending vertically up through a hole in the lid portion 14 and a plunger 40 extending vertically down through a hole in the lid portion 14 to contact the housing portion 12 at the camming interface. A spring 38 is included internally to the safety pin 36 to provide a mechanism by which the plunger 40 may secure the lid portion 14 to the housing portion 12. Preferably, as shown in FIG. 3, the safety pin 36 is threaded into the hole through the lid portion 14, so as to secure the safety pin to the lid portion 14.

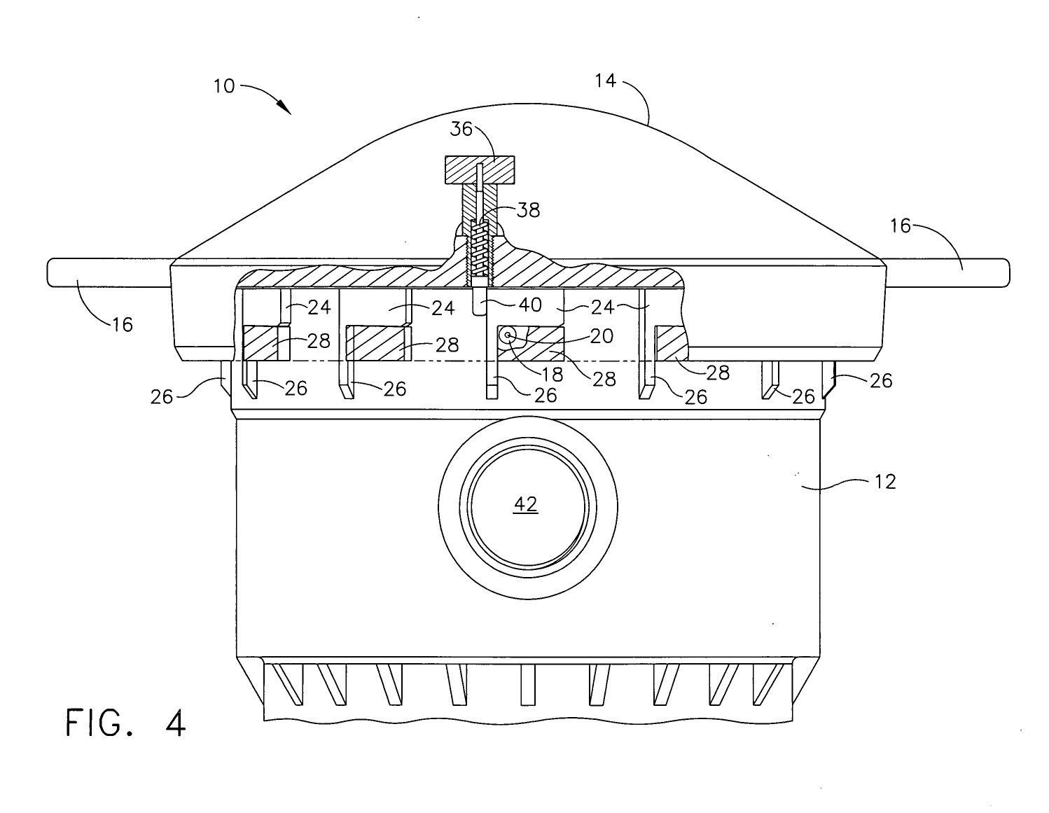

As seen in FIG. 4, a camming interface is included in the present invention to connect the lid portion 14 to the housing portion 12 and provide a more secure connection than in known fluid filtering systems. On the housing portion 12, cam members with a circumferentially extending locking portion 24 and longitudinally extending stops 26 are included. On the lid portion 14, locking members 28 are located so as to engage the cam locking portions 24 and stops 26 on the housing portion 12, fitting under locking portions 24 and completing their transit when the lid portion 14 is engaged with the housing portion 12, with the locking members 28 seated against the stops 26. As is seen in cut-away in FIG. 4, the vent bores 20 and vent gaskets 18 are located on the housing portion 12 below the portions 24 and adjacent the stops 26. As such, when the cam locking members 28 of the lid portion 14 are engaged with the portions 24 and the stops 26, the vent bores 20 are covered by the locking members 28.

Prior to use of the fluid filter assembly 10, a filter element must be installed in the housing portion 12 through the access opening 22. Initially, the lid portion 14 is removed, if not already. A filter element is then longitudinally inserted in the access opening 22, as disclosed in U.S. patent application Ser. Nos. 10/972,976 and 10/972,978.

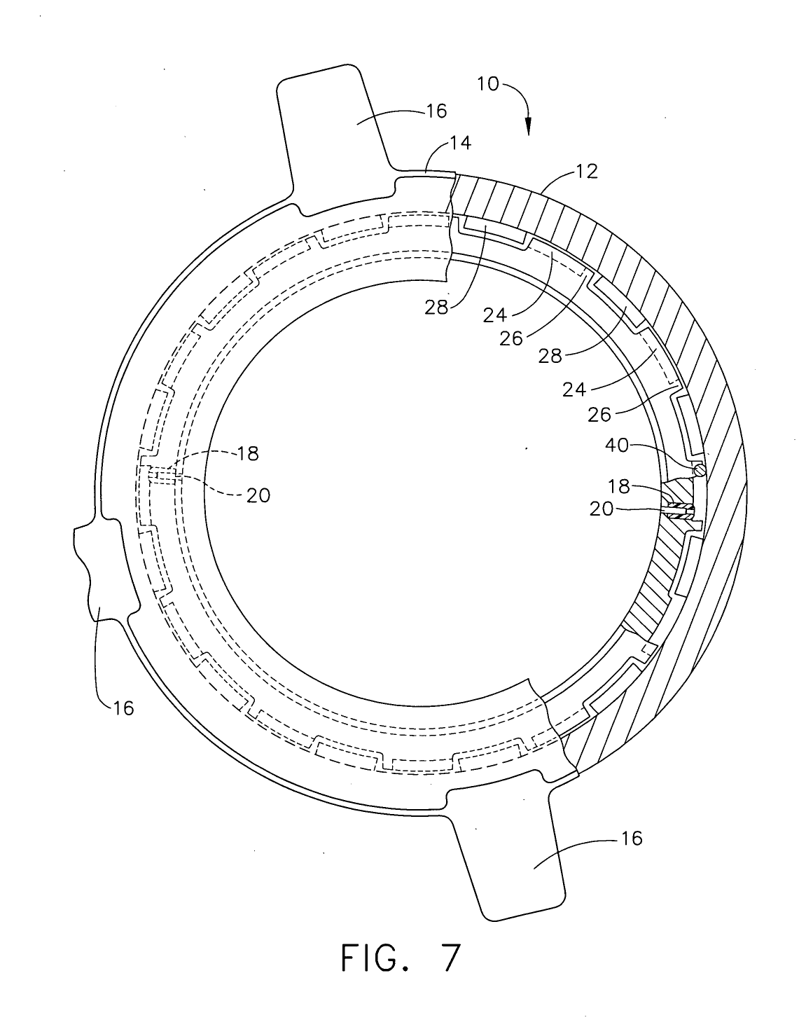

The lid portion 14 is then positioned over the housing portion 12, as shown in FIG. 7. As can be seen in FIG. 7, lid portion 14 cam locking members 28 are initially spaced between the cam member locking portions 24 and stops 26 of the housing portion 12. The lid portion 14 is fitted downward over the upper lip of the housing portion 12, causing the gasket 32 to interface and come into contact with the inner radial surface 34 of the housing portion 12. The safety pin 36, meanwhile, is pushed upward, and its spring 38 depressed, as the plunger 40 contacts the circumferentially extending locking portion 24 of one of the cam members of the housing portion 12. With the safety pin 36 in this upward extending position, a visual indication is given to an operator of the fluid filtering system of the present invention that the lid portion 14 and the housing portion 12 are not yet properly seated.

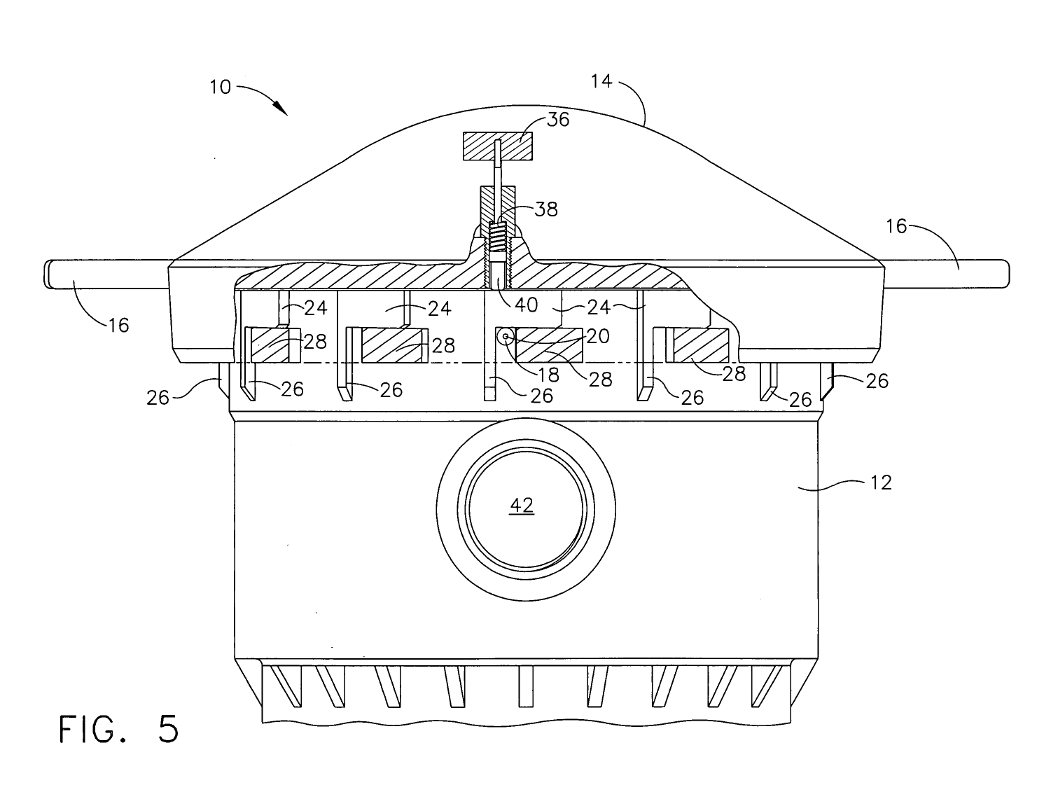

To secure the lid portion 14 to the housing portion 12, the lid handles 16 are used to twist the lid portion 14 in a clockwise direction, as shown in the illustrated embodiment of FIG. 5. As can be seen, the cam locking members 28 of the lid portion 14 travel under the cam locking portions 24 and come into engagement therewith. Preferably, the cam locking portions 24 of the housing portion 12 are tapered so that the portion engaged by the cam locking members 28 of the lid portion 14 is angled upward from right to left a few degrees from the horizontal, as seen in FIG. 5. This upward angling further secures the lid portion 14 to the housing portion 12, so as to require extra force in a downward direction be exerted when the lid portion 14 is removed from the housing portion 12.

When the cam locking members 28 of the lid portion 14 have completed their transit under the cam locking portions 24 of the housing portion 12, and are seated against the stops 26, the plunger 40 of the safety pin 36 snaps down, as the spring 38 is allowed to extend once again, the plunger 40 having traversed the circumferentially extending locking portion 24, as is seen in FIG. 4. The plunger 40 is now seated against an outer edge of the locking portion 24, preventing the lid portion 14 from being able to be twisted off in a counter-clockwise direction accidentally. This engagement of the lid portion 14 and the housing portion 12 can also be seen in a closed position in FIG. 1.

With the lid portion 14 secured to the housing portion 12, and the access opening 22 closed, fluid is introduced into the housing portion 12 through the inlet opening 42, allowed to pass through the filter element (not shown) and out through the outlet opening (not shown). The fluid filtering system is also preferably pressurized at this time. Should the lid portion 14 be incorrectly seated on the housing portion 12 at the gaskets 32, fluid would be allowed to pass through an opening between the lid portion 14 and the housing portion 12 that is sealed by the gasket 32. Visual indication of fluid on the outside of the filter housing 12 would indicate to the operator of the fluid filtering system that the system is operating incorrectly and would prompt the operator to cease fluid filtering operations. Alternately, if the lid portion 14 is incorrectly seated on the housing portion 12 at the vent bores 20 and vent gaskets 18, fluid would be allowed to pass through the vent bores 20 and fluid would appear on the outside of the filter housing 12 to indicate to the operator of the fluid filtering system that fluid is leaking and to prompt the operator to shut the system down.

When removing the lid portion 14 from the housing portion 12, the sequence of events described above is carried out. First, the safety pin 36 must be lifted so as to release the plunger 40 from its position seated against an outer edge of the locking portion 24, depressing the spring 38. Simultaneously, the lid handles 16 are used to unseat the locking members 28 of the lid portion 14 from their positions under the locking portions 24 of the housing portion 12, turning the lid portion 14 in a counter-clockwise direction, as shown in FIG. 5. By inclusion of both the safety pin 36 and the camming interface with locking members 28 on the lid portion 14 and locking portions 24 on the housing portion 12, an operator must use two hands and downward pressure on the lid portion 14 to successfully release the lid portion 14 from the housing portion 12. These safety features provide improved assurance of a successful interface of the housing portion 12 and the lid portion 14.

From the above description, it will be apparent that the invention disclosed herein provides a novel and advantageous system for support and stabilization of a recreational vehicle. The foregoing discussion discloses and describes merely exemplary methods and embodiments of the present invention. As will be understood by those familiar with the art, the invention may be embodied in other specific forms and utilize other materials without departing from the spirit or essential characteristics thereof. Accordingly, the disclosure of the present invention is intended to be illustrative, but not limiting, of the scope of the invention, which is set forth in the following claims.

1. A fluid filter assembly, comprising:
a housing portion having an access opening and an interior surface defining a fluid passage having an inlet and an outlet;
a lid portion removably securable to the housing portion by a camming interface;
a filter element adapted to filter a fluid passing therethrough; and
a gasket sealingly disposed between the lid portion and the housing portion;
wherein the camming interface includes camming members on both the housing portion and the lid portion,
a vent bore in the housing portion adjacent a housing portion camming member, a safety pin in the lid portion, wherein the safety pin serves to selectively allow the lid portion to be removably secured to the housing portion, said housing portion camming member including a depending stop, said vent bore located at one side of said stop, said safety pin including a plunger, wherein the plunger transverses said camming member of the housing portion and comes into seating engagement adjacent the stop of the camming member at its opposite side from the vent bore as said camming member covers and seals said vent when the lid portion is removably secured through the housing portion.

2. (canceled)

3. (canceled)

4. The fluid filter assembly of claim 1, further comprising a vent gasket removably secured within the vent bore, one portion of the vent gasket extending laterally through the vent bore and another portion extending laterally from an exterior surface of the housing portion.

5. The fluid filter assembly of claim 1, further comprising a plurality of vent bores and vent gaskets.

6. (canceled)

7. (cancelled)

8. The fluid filter assembly of claim 1, wherein the filter element includes a filter basket and a filter bag engageable with the filter basket.

9. The fluid filter assembly of claim 1, wherein the filter element includes a filter cartridge.

10. The fluid filter assembly of claim 1, wherein each camming member of the housing portion includes a circumferentially extending portion and a longitudinally extending stop.

11. A method of filtering a fluid, comprising:
providing a filter housing portion having an access opening and an interior surface defining a fluid passage having an inlet and an outlet;
positioning a filter element adapted to filter a fluid passing therethrough within the fluid passage;
providing a filter lid portion removably securable to the housing portion by a camming interface and a gasket sealingly disposed between the filter lid portion and the filter housing portion;
positioning the filter lid portion over the access opening and removably securing the lid portion to the filter housing portion; and
passing fluid through the filter housing portion and the filter element from the inlet to the outlet;
wherein the camming interface includes camming members on both the filter housing portion and the filter lid portion,
providing a vent bore in the filter housing portion, at least one of said housing portion camming members including a depending stop, said vent bore located at one side of the stop,
providing the safety pin in the filter lid portion with the safety pin serving to selectively allow the filter lid portion to be removably securable to the filter housing portion in abutting contact with said one camming member, said safety pin including a plunger, wherein the plunger after traversing said one camming member extends into seating engagement adjacent the stop at its opposite side from the vent bore as the filter lid portion is secured to the filter housing portion and the one camming member overlies and seals the vent bore in the housing filter portion.

12. The method of claim 11, wherein the gasket further includes an open end in fluid communication with fluid conveyed within the filter housing portion.

13. (canceled)

14. The method of claim 11 further including the step of providing a plurality of vent gaskets removably secured within the plurality vent bores, one portion of the vent gaskets extending laterally through the vent bores and another portion extending laterally from an exterior surface of the filter housing portion.

15. (canceled)

16. (canceled)

17. The method of claim 11, wherein each camming member of the housing portion includes a circumferentially extending portion and a longitudinally extending stop.

18. The method of claim 17, further including the step of securing each of the filter lid camming members under each of the housing lid camming members.

19. The method of claim 18, further including the step of positioning each of the filter lid camming members over the plurality of vent bores and vent gaskets removably secured therein.

20. The method of claim 19, further including the step of visually inspecting the fluid filter assembly for fluid leakage from the camming interface.
